(19) United States
(12) Patent Application Publication
(10) Pub. No.: US 2013/0049381 A1
(43) Pub. Date: Feb. 28, 2013

(54) MANWAY COVER FASTENER

(71) Applicants: David C. Hageman, Chagrin Falls, OH (US); Richard L. Dudman, Euclid, OH (US)

(72) Inventors: David C. Hageman, Chagrin Falls, OH (US); Richard L. Dudman, Euclid, OH (US)

(21) Appl. No.: 13/325,696

(22) Filed: Dec. 14, 2011

Related U.S. Application Data
(60) Provisional application No. 61/529,518, filed on Aug. 31, 2011.

(51) Int. Cl. E05C 3/00

(52) U.S. Cl. 292/212

(57) ABSTRACT

A fastener includes a housing, a piston movable within the housing, and a compression member positioned between the housing and the piston. The compression member is movable entirely into the housing to compress the compression member.

### RELATED APPLICATIONS

This application claims priority from U.S. Provisional Application Ser. No. 61/529,518, filed Aug. 31, 2011, the subject matter of which is incorporated herein in its entirety.

### TECHNICAL FIELD

The present invention relates to fasteners and, in particular, relates to a compression-loaded fastener for a manway cover.

### BACKGROUND

Manway covers are used frequently in industry and travel to cover ingress and egress openings of storage compartments. The covers may inhibit human access to interior compartments and/or may prevent contents in those compartments, e.g., chemicals, grain, etc., from spilling or unwontedly exiting the compartment. It therefore becomes desirable to provide fasteners that adequately secure the cover to the remainder of the storage compartment. Such a fastener should reliably secure the cover over a range of environmental conditions, e.g., vibration or extreme weather.

### SUMMARY OF THE INVENTION

In accordance with an embodiment of the present invention a fastener includes a housing, a piston movable within the housing, and a compression member positioned between the housing and the piston. The compression member is movable into the housing to compress the compression member. In one embodiment, the piston is movable entirely into the housing. In another embodiment, the compression member exerts a radially outward force upon the housing when the piston moves in the housing.

In accordance with another aspect of the present invention a fastener for a manway cover of a rail car includes a bolt that extends along an axis from a first end to a second end. The first end includes threads and the second end includes a head that has an opening for securing the bolt to the rail car. A nut is threadably engaged with the threads of the bolt and is movable along the axis of the bolt. A housing is connected to the bolt between the nut and the opening in the head of the bolt. A compression member is positioned within the housing. A piston engages the compression member and the manway cover. The piston is moveable into the housing to compress the compression member in response to axial movement of the nut. The housing acts as a hard stop against the manway cover to indicate when the fastener is locked to the manway cover.

In accordance with another aspect of the present invention a method for securing a manway cover to a rail car includes providing a housing, a piston movable within the housing, and a compression member positioned between the housing and the piston. A bolt is inserted through the housing, the bolt extending along an axis from a first end to a second end, the first end including threads and the second end including a head having an opening for securing the bolt to the rail car. The piston is positioned on the manway cover. A nut is threadably engaged with the threads of the bolt. The nut rotates in a first direction to cause movement of the piston into the housing to compress the compression member, the housing acting as a hard stop against the manway cover to indicate when the fastener is locked to the manway cover.

Other objects and advantages and a fuller understanding of the invention will be had from the following detailed description of the preferred embodiments and the accompanying drawings.

### BRIEF DESCRIPTION OF THE DRAWINGS

FIGS. 1A-1B are schematic illustrations of a fastener in accordance with an embodiment of the present invention;

FIG. 2A is a side view of the fastener of FIG. 1A;

FIG. 2B is a cross-sectional view taken of FIG. 2A taken along line 2B-2B;

FIGS. 3A-3B are exploded assembly views of the fastener of FIG. 1;

FIG. 4 is another exploded assembly view of the fastener of FIG. 1;

FIG. 5A is a schematic illustration of a rail car using the fastener of the present invention;

FIG. 5B is an enlarged view of the fastener of FIG. 1 securing a manway cover, of the rail car of FIG. 5A; and

FIG. 6 is a cross-sectional view of FIG. 5B taken along line 6-6.

### DETAILED DESCRIPTION

The present invention relates to fasteners and, in particular, relates to a compression-loaded fastener. To facilitate explanation the invention will be described in connection with a rail car manway cover application. It should be noted, however, that the fastener of the present invention can be used in any application in which two objects have a gasketed interface and it is desirable to maintain a compression load between the two objects. For example, the present invention can be used on any soft gasket connection which would include low pressure flanged pipe connections, stationary storage tanks, etc.

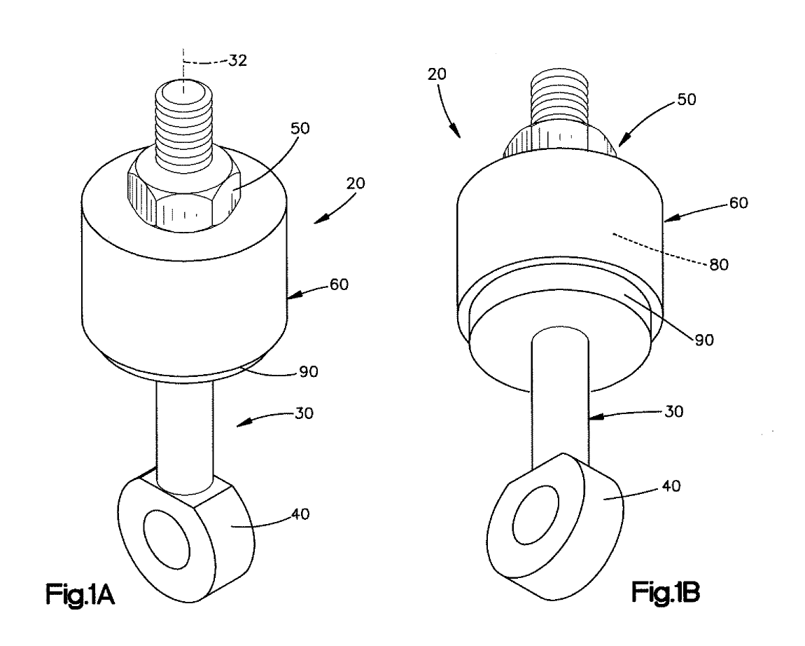

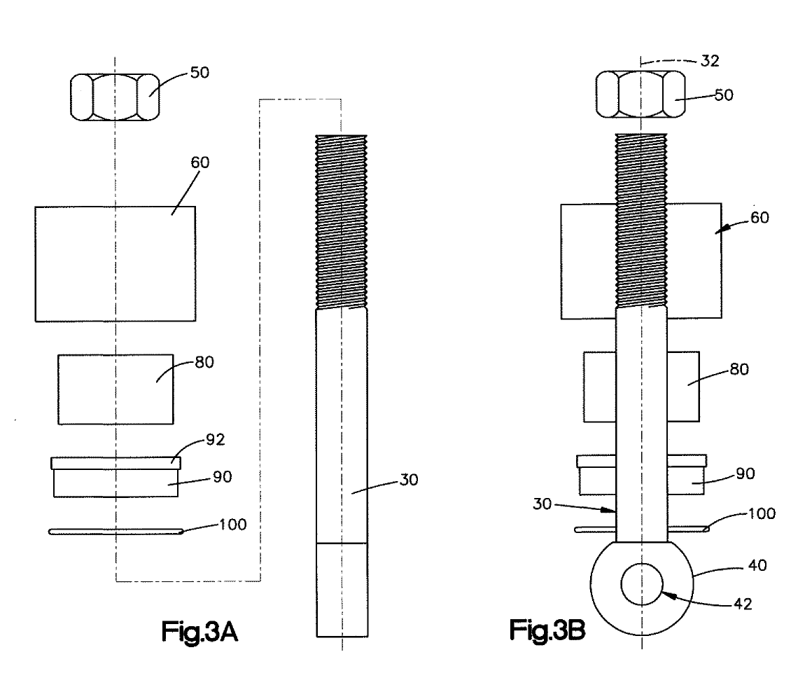

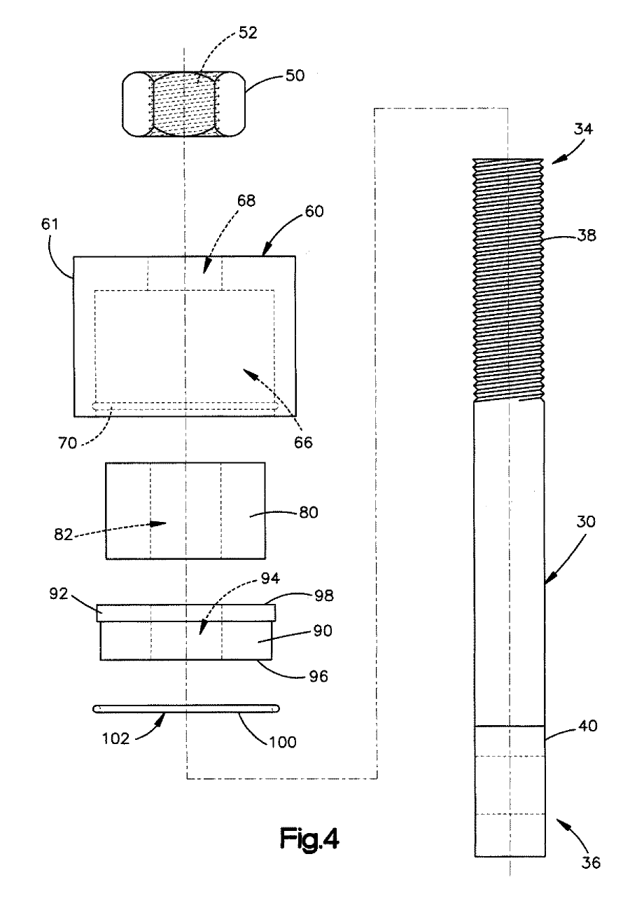

FIGS. 1A-4 illustrate a fastener 20 in accordance with an embodiment of the present invention. The fastener 20 includes a bolt 30 that extends along an axis 32 from a first end 34 to a second end 36. The bolt 30 is circular in cross-section although other shapes, such as square, are contemplated. Threads 38 are formed on the first end 34 of the bolt 30 and extend from the first end towards the second end 36. The threads 38 may be helical, square or the like.

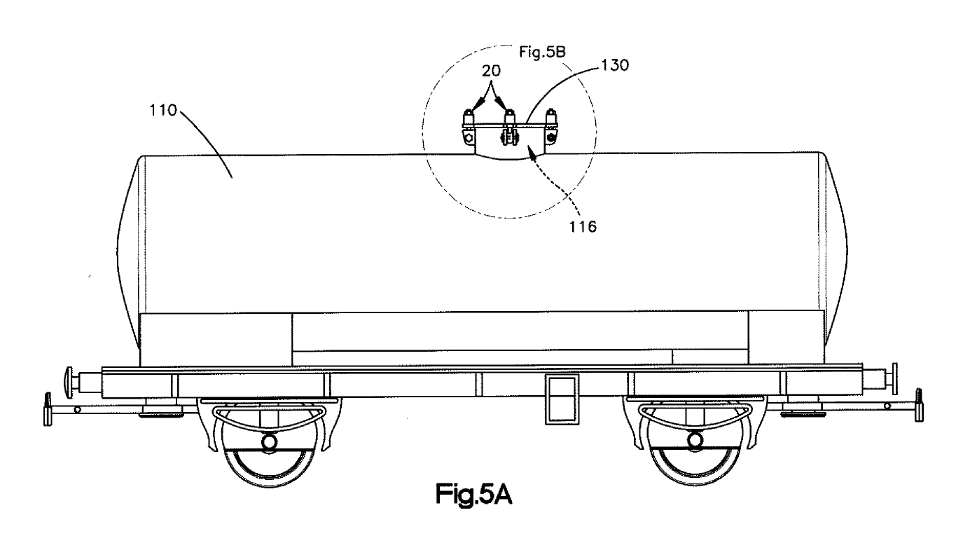

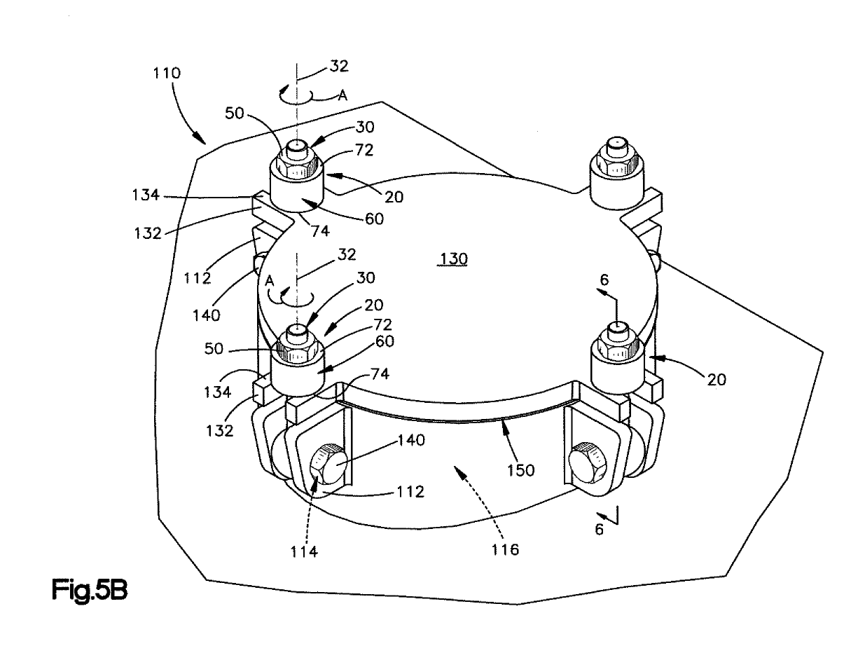

A head 40 is formed on the second end 36 of the bolt 30. The head 40 is circular and includes an opening 42 that extends entirely through the head in a direction that is transverse to the axis 32 of the bolt 30. For example, the opening 42 may extend perpendicular to the axis 32. The bolt 30 therefore exhibits the shape of an eye-bolt. The opening 42 is configured to receive a fastener (shown in FIG. 5B) to help secure the fastener 20 to a structure such as a rail car.

The fastener 20 further includes a nut 50 that has threads 52 for mating with the threads 38 of the bolt 30. The threads 52 may have any configuration, e.g., helical or square, so long as the threads 52 on the nut 50 can threadably engage the threads 38 on the bolt 30. The nut 50 is rotatable relative to the bolt 30 in order to move the nut longitudinally along the axis 32 of the bolt.

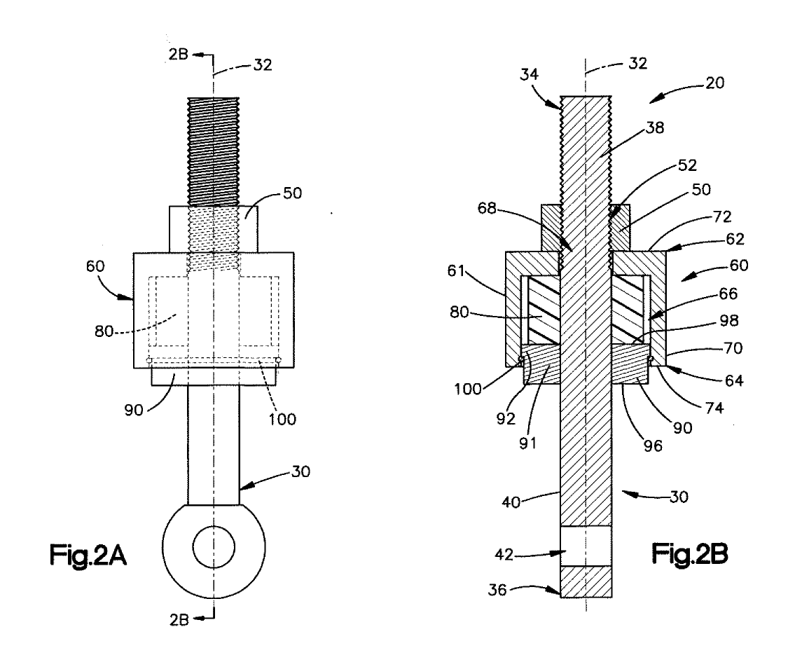

As shown in FIGS. 2A-2B, a housing 60 is positioned along the bolt 30 and between the head 40 of the bolt and the nut 50. The housing 60 has a tubular shape and extends from a first end 62 to a second end 64. The housing 60 includes a sidewall 61 that extends from an axial end surface 72 at a first end 62 to an axial end surface 74 at a second end 64. The sidewall 61 defines an interior chamber 66 that extends from the second end 64 towards the first end 62. A passage 68 extends through the first end 62 of the housing 60 and terminates at the interior chamber 66. An annular recess 70 is formed in the second end 64 of the housing 60 and is spaced from the axial end surface 72. The recess 70 extends radially outward from the axis 32 and terminates prior to reaching the outer surface of the sidewall 61. The passage 68, interior chamber 66, and recess 70 are substantially co-axial with the axis 32 of the bolt 30 and are sized and configured to allow the housing 60 to slide longitudinally along the axis 32 of the bolt 30 and relative to the bolt.

A compression member 80 is positioned entirely within the interior chamber 66 of the housing 60. The compression member 80 is made of a resilient material such as an elastomer and exhibits the same general shape as the interior chamber 66 of the housing 60. Although the compression member 80 is illustrated as a single piece, it will be appreciated that the compression member may alternatively constitute multiple pieces formed of different materials, e.g., materials having different hardness, to meet desired performance criterion. In the preferred embodiment, the compression member 80 is smaller than the interior chamber 66 in the radial direction relative to the axis 32 of the bolt 30. The compression member 80 includes a passage 82 for slidably receiving the bolt 30. The passage 82 extends between opposing axial end surfaces 84, 86 of the compression member 80.

A piston 90 is provided to maintain the compression member 80 within the housing 60. The piston 90 has a generally annular or circular shape that generally mimics the shape of the interior chamber 66 of the housing 60. The piston 90 is sized to be accommodated in the interior chamber 66 and move along the axis 32 relative thereto. More specifically, the piston 90 includes a base 91 and a flange 92 that extends radially outward from the base. The base 91 includes an axial end surface 96 and the flange 92 includes an axial end surface 98. The flange 92 is engageable with and slidable relative to the inner surface of the sidewall 61 of the housing 60. A passage 94 extends through the piston 90 for accommodating the bolt 30. The piston 90 sandwiches the compression member 80 between the first end 62 of the housing 60 and the flange 92 of the piston and can be moved to compress the compression member.

The flange 92 and at least a portion of the base 91 of the piston 90 are maintained within the housing 60 at all times by a lock ring 100. The lock ring 100 has an annular shape and is insertable into the recess 70 in the second end 64 of the housing 60 in order to prevent the piston 90 from fully exiting the interior chamber 66. The lock ring 100 fits over the base 91 of the piston 90 but has a smaller inner diameter than the outer diameter of the flange 92 of the piston. Therefore, the base 91 of the piston 90 extends through the lock ring 100 while the flange 92 cannot pass through the lock ring. Due to this configuration, the lock ring 100 maintains the flange 92 and at least a portion of the piston 90 within the interior chamber 66 of the housing 60 at all times.

When the fastener 20 is assembled the housing 60, compression member 80, piston 90, and lock ring 100 are slid onto the bolt 30 and are movable as a single unit along the bolt. The nut 50 is threaded to the bolt 30 to limit the sliding movement of the housing and associated components 80, 90, 100. In this configuration, the piston 90 has an initial condition that imparts little or no compressive force to the compression member 80. In the illustrated embodiment, the compression member 80 in this state is substantially unstressed and does not engage the sidewall 61 of the housing 60 (see FIGS. 2A-2B). As will be described, the piston 90 is movable along the bolt 30 relative to the nut 50 to compress the compression member 80 in order to create a live-loaded fastener 20 for securing objects together.

The fastener 20 of the present invention is useful in applications where it is desirable to maintain a desirable compression load between two fastened elements, e.g., a storage compartment or housing and corresponding lid or cover that closes a portion of the housing. In one example, the fastener 20 is used to securely close a cover 130 of a train or rail way car 110 as shown in FIGS. 5A-B. The rail car 110 includes an opening 116 through which goods or people can ingress and egress the top of the rail car. A series of outwardly extending lugs or tabs 112 are positioned around the opening 116. In one example, pairs of tabs 112 are spaced around the periphery of the opening 116 in a predetermined pattern, e.g., symmetrically spaced about the periphery of the opening. Each of the tabs 112 in the pair includes a passage 114 extending entirely therethrough in a direction generally following the periphery of the opening 116.

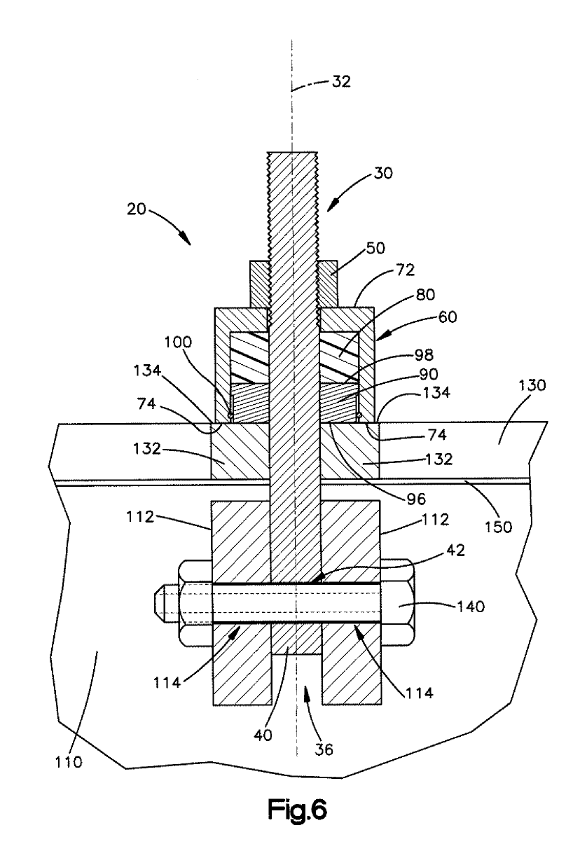

A manway cover 130 is provided to selectively close the opening 116 in the rail car 110. A gasket for compressible seal 150 (see FIG. 6) is provided between the cover 130 and the portion of the rail car 110 defining the opening 116 to fluidly seal the opening. The cover 130 includes a series of radially extending projections or fingers 132 that are numbered and positioned to correspond with the tabs 112 formed on the rail car 110. As shown in FIG. 5B, four pairs of fingers 132 on the manway cover 130 are aligned with four corresponding pairs of tabs 112 on the rail car 110. Although not shown, the cover 130 may be pivotably connected to the rail car 110 by one or more hinges in accordance with the present invention.

When it is desirable to seal the opening 116 in the rail car 110, the gasket 150 is placed around the opening between the cover 130 and the rail car and the cover is closed to place each pair of fingers 132 on the cover in alignment with a corresponding pair of tabs 112 on the rail car. The nut 50 on the assembled fastener 20 is positioned near the first end 34 of the bolt 30 and the housing 60—along with the compression member 80, piston 90, and lock ring 100—is positioned adjacent to the nut. The fastener 20 is oriented generally as shown in FIGS. 1A-1B and the head 40 of the bolt 30 is inserted between the tabs 112 on the rail car 110 such that the opening 42 in the head is aligned with the openings 114 in the tabs. This places the axis 32 of the bolt 30 between both the pair of fingers 132 and the pair of corresponding tabs 112. In this configuration—shown in FIGS. 5B and 6—the housing 60 is positioned on a side of the fingers 132 opposite from the head 40 of the bolt 30 such that the axial end surface 96 of the piston 90 engages a top surface 134 of each finger 132. At this point, the compression member 80 remains substantially uncompressed and the base 91 of the piston 90 extends nearly entirely out of the housing 60, i.e., the piston is in a first or initial condition in which it is visible.

A fastener 140, such as a pin or bolt, is inserted through the openings 114 in the tabs 112 and the opening 42 in the head 40 of the bolt 30 in order to secure the fastener 20 to the rail car 110. The pin 140 forms an axis of rotation between the fastener 20 and the tabs 112 of the rail car 110. If desired, the pin 140 can be inserted through the openings 114 and the fastener 20 can be subsequently pivoted upwards toward the cover 130 until the upright bolt 30 extends through the fingers 132 and the housing 60 is positioned above the top surface 134 of the fingers. In any case, the process is repeated for each fastener 20 positioned and secured to each pair of fingers 132 in the cover 130 and corresponding tabs 112 on the rail car 110.

Due to the initial, uncompressed condition of the compression member 80, the housing 60, compression member, piston 90, and lock ring 100 may move freely along the bolt 30, i.e., the housing fits loosely on the bolt. In this condition, each housing 60 can be moved away from the cover 130 to allow the bolts 30 to be pivoted downward about the pins 140 to disconnect the bolts from the cover 130 and thereby allow the cover to be opened or removed.

The fasteners 20 can be rigidly secured to the cover 130 to seal the opening 116 once all the fasteners are in the aforementioned upright position. To secure each fastener 20 to the cover 130, the nut 50 is rotated about the axis 32 of the bolt 30 in the manner indicated generally by the arrow “A” in FIG. 5B to cause longitudinal movement of the nut along the axis and towards the fingers 132 of the cover. Thread lubricant (not shown) may be used between the bolt 30 and the nut 50 to ensure friction control. As the nut 50 rotates, the distance between the nut and the first axial end surface 72 of the housing 60 decreases until the nut engages the housing. Since the fingers 132 of the cover 130 are fixed in place further rotation of the nut 50 causes the housing 60 to move closer to the fingers against the bias of the compression member 80. More specifically, the piston 90 remains engaged with the top surface 134 of the fingers 132 while the housing 60 is urged downward relative to the piston and the compression member 80. As the housing 60 moves towards the fingers 132 relative to the piston 90 the fingers urge the piston towards the nut 50 and into the interior chamber 66 of the housing 60. The flange 92 of the piston 90 slides along the inner surface of the sidewall 61 of the housing 60, causing compression of the compression member 80 between the axial end surface 98 of the piston and the first end 62 of the housing. The compression member 80 is compressed along the axis 32 of the bolt 30 while radially expanding until the compression member engages the inner surface of the sidewall 61 of the housing 60. As the compression member 80 becomes further compressed with subsequent rotation of the nut 50 it begins to exert a radially outward force upon the sidewall 61 of the housing 60.

The nut 50 is further rotated until the top surfaces 134 of the fingers 132 abut the first axial end surface 72 of the housing 60. In this configuration, the axial end surface 96 of the piston 90 is flush with both the top surface 134 of the fingers 132 and the axial end surface 72 of the housing 60, thereby placing the piston in a second or final condition in which the piston is completely concealed. The moving housing 60 thereby provides a hard stop to tightening of the fastener 20. In the preferred embodiment, when the piston 90 reaches the second condition the compression member 80 has not reached a fully compressed state to help the compression member maintain loading over time. Alternatively, the compression member 80 may be fully compressed when the piston 90 reaches the second condition (not shown).

The radially outward force of the compression member 80 is increased as the distance between the nut 50 and the piston 90 decreases, thereby locking together the housing 60, compression member 80, and bolt 30. Accordingly, the compression member 80 provides frictional resistance to relative movement between the components of the fastener 20 in order to securely lock each fastener to the cover 130, gasket 150, and rail car 110. The compression member 80 thereby supplements the clamping force of the fastener 20. The compression member 80 also ensures that the fastener 20 maintains a clamping force even if the threaded engagement between the nut 50 and the bolt 30 loosens or is compromised.

The piston 90 of the present invention advantageously provides visual indication of the condition of the compression member 80. As noted, the piston 90 goes from an initial condition in which a portion of the piston is visible between the first axial end surface 72 of the housing 60 and the top surface 134 of the fingers 132 to a final condition in which the piston is not visible, i.e., the piston is positioned completely within the housing. The visibility of the piston 90 indicates when the compression load of the compression member 80 is maintained. In particular, if the piston 90 is visible by more than a predetermined amount, e.g., 1/16″, the fastener 20 is insufficiently tightened. On the other hand, if the piston 90 is not visible at all or visible by less than a predetermined amount, e.g., 1/16″, the fastener 20 is providing and maintaining an adequate compression load between the manway cover 130 and rail car 110.

Furthermore, due to the configuration of the fastener 10 of the present invention, once the piston 90 is positioned entirely within the housing 60 and the compression member 80 compressed or loaded, the nut 50 is still movable along the bolt 30. The nut 50 can be further rotated after the housing 60 reaches the hard stop on the fingers 132 to further compress the gasket 150 between the manway cover 130 and the rail car 110. This configuration ensures that the fastener 20 remains tensioned and the gasket 150 compressed over time.

The housing 60 and compression member 80 of the present invention provide a “follow down” capacity to the fastener 20 to maintain compression loading even if the compression member 80 compresses over time. More specifically, the fastener 20 maintains high compression loads with a compression member 80 axial deformation of up to, for example, about 1/16″. Once the fasteners 20 are tightened they may not need retightening for the life of the compression member 80 while still maintaining adequate compression loads. The axial deformation of the compression member 80 may be, for example, attributable to structural changes such as creep and relaxation in the gasket 150 over time due to environmental conditions and the like. The amount of compression of the compression member 80 may increase or decrease to compensate for changes to the gasket 150 over time in order to maintain desired compression loads between the cover 130, gasket 150, and rail car 110.

In conventional fasteners the bolt elongation—which is in thousandths of an inch—is all that can make up for any loss in fastener compression load due to gasket compression. By using the compression member 80, housing 60, and piston 90 of the present invention, however, greater compression load losses can be accounted for and visual indication of the load loss via piston exposure helps to ensure fastener 20 tightening before the gasket begins to leak.

The preferred embodiments of the invention have been illustrated and described in detail. However, the present invention is not to be considered limited to the precise construction disclosed. Various adaptations, modifications and uses of the invention may occur to those skilled in the art to which the invention relates and the intention is to cover hereby all such adaptations, modifications, and uses which fall within the spirit or scope of the appended claims.

Having described the invention, the following is claimed:

1. A fastener comprising:
a housing;
a piston movable within the housing; and
a compression member positioned between the housing and the piston, wherein the piston is movable entirely into the housing to compress the compression member.

2. The fastener according to claim 1, wherein the compression member applies a radially outward force to the housing when the piston is positioned entirely within the housing.

3. The fastener according to claim 1, wherein the compression member applies a first radially outward force to the housing when the piston extends out of the housing and a second radially outward force to the housing greater than the first radially outward force when the piston is positioned entirely within the housing.

4. The fastener according to claim 1, wherein the compression member is an elastomeric solid.

5. The fastener according to claim 1 further comprising a lock ring that cooperates with the housing to prevent the piston from fully exiting the housing.

6. The fastener according to claim 1, wherein the housing includes an axial end surface and the piston includes a first axial end surface that engages the compression member and a second axial end surface opposite the first axial end surface, the compression member being locked with the housing when the second axial end surface of the piston is coplanar with the axial end surface of the housing.

7. The fastener according to claim 1, wherein the housing is mounted to a bolt, the housing being movable along the bolt when the piston extends out of the housing, the housing being rigidly secured to the bolt when the piston is positioned entirely within the housing.

8. The fastener according to claim 1, wherein the housing acts as a hard stop to indicate when the compression member is locked to the housing.

9. The fastener according to claim 1, wherein the compression member is not fully compressed when the piston is positioned entirely within the housing.

10. A fastener for a manway cover of a rail car comprising:
a bolt that extends along an axis from a first end to a second end, the first end including threads and the second end including a head having an opening for securing the bolt to the rail car;
a nut threadably engaged with the threads of the bolt and movable along the axis of the bolt;
a housing connected to the bolt between the nut and the opening in the head of the bolt;
a compression member positioned within the housing; and
a piston that engages the compression member and the manway cover, the piston being moveable into the housing to compress the compression member in response to axial movement of the nut, the housing acting as a hard stop against the manway cover to indicate when the fastener is locked to the manway cover.

11. The fastening according to claim 10, wherein the piston can be placed on the manway cover, the nut being movable in a first direction along the bolt towards the manway cover to move the piston entirely within the housing.

12. The fastener according to claim 11, wherein the nut is movable along the axis of the bolt towards the manway cover after the piston is positioned entirely within the housing.

13. The fastener according to claim 10, wherein the nut is movable along the axis of the bolt while maintaining the piston entirely within the housing.

14. The fastener according to claim 10, wherein the compression member applies a first radially outward force to the housing when the piston extends out of the housing and a second radially outward force to the housing greater than the first radially outward force when the piston is positioned entirely within the housing.

15. The fastener according to claim 10, wherein the compression member is an elastomeric solid.

16. The fastener according to claim 10 further comprising a lock ring that cooperates with the housing to prevent the piston from fully exiting the housing.

17. The fastener according to claim 10, wherein the housing includes an axial end surface and the piston includes a first axial end surface that engages the compression member and a second axial end surface opposite the first axial end surface, the compression member being locked with the housing when the second axial end surface of the piston is coplanar with the axial end surface of the housing.

18. The fastener according to claim 10, wherein the housing is mounted to a bolt, the housing being movable along the bolt when the piston extends out of the housing, the housing being rigidly secured to the bolt when the piston is positioned entirely within the housing.

19. The fastener according to claim 10, wherein the compression member is not fully compressed when the piston is positioned entirely within the housing.

20. The fastener according to claim 10, wherein the housing, compression member, and piston are slidable as a unit along the bolt prior to the prison moving entirely into the housing.

21. The fastener according to claim 10, wherein the entire piston is moveable into the housing to compress the compression member in response to axial movement of the nut.

22. A method for securing a manway cover to a rail car comprising:
providing a housing, a piston movable within the housing, and a compression member positioned between the housing and the piston;
inserting a bolt through the housing, the bolt extending along an axis from a first end to a second end, the first end including threads and the second end including a head having an opening for securing the bolt to the rail car;
positioning the piston on the manway cover;
threadably engaging a nut with the threads of the bolt; and
rotating the nut in a first direction to cause movement of the piston into the housing to compress the compression member, wherein the housing acts as a hard stop against the manway cover to indicate when the fastener is locked to the manway cover.

23. The method according to claim 22 comprising rotating the nut in the first direction to cause the entire piston to move into the housing to compress the compression member.

24. The method according to claim 23 further comprising further rotating the nut in the first direction to move the nut closer to the manway cover while the piston is positioned entirely within the housing.

25. The method according to claim 23, wherein the compression member is not fully compressed when the piston is positioned entirely within the housing.

26. The method according to claim 22, wherein rotation of the nut causes the compression member to move from a first position exerting a first radially outward force upon the housing to a second position exerting a second radially outward force upon the housing greater than the first radially outward force.

27. The method according to claim 23, wherein rotating the nut in the first direction moves the nut towards the manway cover.
